(19) United States
(12) Patent Application Publication
(10) Pub. No.: US 2004/0089492 A1
(43) Pub. Date: May 13, 2004

(54) Vehicle with inclined engine

(75) Inventor: Donn Eide, Thief River Falls, MN (US)

Correspondence Address: MERCHANT & GOULD PC, P.O. BOX 2903, MINNEAPOLIS, MN, 55402-0903, US

(73) Assignee: Arctic Cat, Inc., Thief River Falls, MN

(21) Appl. No.: 10/290,842

(22) Filed: Nov. 7, 2002

(51) Int. Cl. B60K 5/00

(52) U.S. Cl. 180/291

(57) ABSTRACT

A vehicle having a vehicle body and an engine disposed therein. The engine is backwardly inclined within the vehicle, such that the angle between the axes of the engine cylinders and the plane of the surface upon which the vehicle rests form an angle of less than 90 degrees in a direction away from the front end of the vehicle. The center of mass of the vehicle with the engine inclined may be lower than if the engine were not inclined. The center of mass of the vehicle with the engine inclined may be further from the front end of the vehicle than if the engine were not inclined. The center of mass of the vehicle with the engine inclined may be aligned vertically with the vehicle operator, the drive shaft of the vehicle, or the geometric center of the vehicle. The performance of the vehicle with the engine inclined may be better than if the engine were not inclined. The engine air intake, engine exhaust port, and carburetor or other fuel and/or air inlet device may extend from the engine towards the front end of the vehicle.

### BACKGROUND OF THE INVENTION

1. Field of the Invention

The invention relates to a vehicle such as a snowmobile having an engine disposed therein that is backwardly inclined with respect to the front of the vehicle, to a method for arranging an engine in a vehicle with a backward incline, and to a method for changing the center of mass of a vehicle by backwardly inclining the engine thereof.

2. Description of Related Art

Vehicles for carrying persons and/or cargo are well known. Many such vehicles have engines disposed inside of them to enable such vehicles to move under their own power.

Conventionally, vehicles, such as snowmobiles, include a vehicle body with an engine disposed at some location within the body. In conventional vehicles, the engine is mounted vertically, as seen from the point of view of the pistons and cylinders. That is, the axis defined by the engine's cylinders is generally perpendicular relative to the plane upon which the vehicle rests, i.e. the ground.

In such conventional vehicles, the engine's air intake normally is arranged on the side of the engine furthest from the front of the vehicle. The engine's exhaust outlet typically is mounted on the side of the engine closest to the front of vehicle.

However, such an arrangement has disadvantages.

Typically, the engine is mounted within the body in an engine compartment occupying some portion of the front of the vehicle. In order to allow space for the air intake, and oftentimes for additional equipment such as a carburetor or other fuel and/or air inlet device, the engine is mounted relatively far forward in the engine compartment, and thus relatively far forward in the vehicle.

However, in order to turn and otherwise maneuver a vehicle effectively, it is generally desirable to have the vehicle's center of mass coincide with or be relatively close to the center of rotation of the vehicle in a particular maneuver. This enables rapid and efficient turns with low stress upon the vehicle body. Generally, the center of rotation of the vehicle is at or near its geometric center. Thus, it is desirable for the center of mass of the vehicle to be at least approximately coincidental with the geometric center of the vehicle.

In addition, vehicles with their center of mass aligned with their geometric center tend to be more stable, and are less affected by pitching and rolling motions. This is at least in part because, with the center of mass and the geometric center aligned, the angular moment of inertia of the vehicle is relatively low.

For example, in a vehicle with a large amount of mass near its front end, if the front end is made to pitch, for example by traversing rough or uneven terrain, the pitching motion has a relatively high total angular momentum, because of the heavy, unbalanced front end. In contrast, if a vehicle with the center of mass and geometric center aligned is made to pitch, the pitching motion has a relatively low total angular momentum.

Thus, in a vehicle with the center of mass and geometric center aligned the pitching motion is more readily damped out or compensated for than would be the case in a vehicle with, for example, a large mass in its front end.

This is true to at least some extent with regard to rolling and yawing motions, as well. As a result, aligning the center of mass and geometric center of a vehicle is advantageous in providing stable and controllable operation.

For vehicles that move across a surface, these considerations are somewhat simplified. For purposes of surface movement, if the center of mass aligns vertically with the geometric center of the vehicle from front to back and side to side (i.e. within the plane of the surface on which it travels), it is equivalent to having the vehicle's center of mass coincidental with the vehicle's geometric center.

In other words, for a conventional surface vehicle, it is advantageous for vehicle's center of mass to “line up” with the vehicle's midpoint. It may also be advantageous for certain vehicles if the vehicle's center of mass aligns with the location of the vehicle operator, or with the location of a drive component such as the drive shaft.

However, because the engine is mounted far forward within a conventional vehicle, and because the mass of the engine often makes up a significant portion of the total mass of the vehicle, the center of mass of a conventional vehicle often is relatively close to the front of the vehicle, and relatively far from the vehicle's midpoint, the location of the vehicle operator, and the location of the drive shaft or other relevant drive components.

In addition, in order to provide stability, responsiveness, and smoothness of ride in a vehicle, it is generally desirable to have the vehicle's center of mass be as low as possible, that is, close as possible to the surface upon which the vehicle rests.

However, because vehicle engines conventionally are mounted vertically, and typically are greater in height than in length (as measured front to back in the vehicle body), their center of mass is relatively high. Again, because the engine often makes up a significant portion of the vehicle's mass, this means that the center of mass of the vehicle as a whole is relatively high.

Furthermore, the arrangement of the air intake behind the engine with the exhaust in front of the engine, as is conventional in vertical-engine vehicles, has disadvantages in itself.

In many vehicles, the fuel tank is located behind the engine. However, when the air intake, fuel and/or air inlet device, etc. is also disposed behind the engine, the space available for the fuel tank is reduced. As a result, less fuel can be carried than might otherwise be the case, and the vehicle's range is reduced.

Also, in many vehicles the vehicle operator is positioned behind the engine. Because of this arrangement, the air intake is often quite close to the vehicle operator in conventional vehicles. As a result, engine noise can be readily transmitted to the operator via the air intake in such vehicles.

### SUMMARY OF THE INVENTION

It is the purpose of the claimed invention to overcome these difficulties, thereby providing a vehicle with an improved maneuverability, greater stability, increased fuel capacity, and/or decreased perceived noise during operation.

An exemplary embodiment of a vehicle in accordance with the principles of the claimed invention includes a vehicle body adapted to rest substantially on a plane, such as ground, snow, water, etc. The vehicle has an engine disposed within the vehicle body.

The engine is inclined backwardly within the vehicle body. The engine oriented such that the axes defined by the engine's cylinders form an angle with the plane. The angle between the axes and the plane, in the direction away from the front of the vehicle body, is less than 90 degrees.

In certain embodiments, the angle may be smaller, i.e. less than 75 degrees, less than 60 degrees, less than 45 degrees, or less than 30 degrees.

In some embodiments, the angle of the engine may correspond approximately to the slope of the surface of the body near the engine. For example, the angle of the engine may be within 10 degrees of the slope of the body surface, or may be within 5 degrees of the slope of the body surface.

With the engine inclined to form an angle of less than 90 degrees as noted, the center of mass of the vehicle may be lower than it otherwise would be if the engine were not so inclined. In certain embodiments this feature may not derive entirely from the change in the location of the center of mass from the angling of the engine, per se. Inclining the engine as indicated also, for certain embodiments, may enable the engine to be mounted lower than it otherwise could be.

Likewise, with the engine inclined to form an angle of less than 90 degrees as noted, the center of mass of the vehicle may be further from the front of the vehicle than it otherwise would be if the engine were not so inclined.

In certain embodiments, the center of mass of the vehicle may be substantially vertically aligned with the location of a vehicle operator. In certain embodiments, the center of mass of the vehicle may be substantially vertically aligned with the drive shaft of the engine. Also, in certain embodiments, the center of mass of the vehicle may be substantially vertically aligned with the geometric center of the vehicle.

The turning radius of a vehicle with the engine inclined to form an angle of less than 90 degrees with the plane on which the vehicle rests may have a turning radius smaller than that of the vehicle if the engine were not so inclined.

The vehicle may include an air intake in communication with the engine, with the air intake extending from the engine towards the front end of the body so as to draw air into the engine from the direction of the front end of the body. The vehicle also may include an air exhaust in communication with the engine extending from the engine towards the front end of the body so as to expel air from the engine towards the direction of the front end of the body.

The vehicle may include a fuel and/or air inlet device in communication with the engine. The inlet device may be in communication with the air intake. The inlet device may be disposed closer to the front end of the vehicle than the engine.

The vehicle may be a snowmobile.

A method of mounting an engine in a vehicle in accordance with the principles of the claimed invention includes the step of providing a vehicle body adapted to rest substantially on a plane. An engine is provided, and is disposed within the body inclined in the direction away from the front end of the body, such that the angle between the axes of the engine cylinders and the plane less than 90 degrees.

A method in accordance with the principles of the claimed invention for changing the center of mass of a vehicle having a vehicle body adapted to rest substantially on a plane, and an engine disposed within the body, includes steps as follows. The engine is inclined in the direction away from the front end of the body, such that the angle between the axes of the engine cylinders and the plane less than 90 degrees. When the engine is so inclined, the center of mass of the vehicle moves.

The center of mass of the vehicle may be lower after the engine is inclined. The center of mass of the vehicle may be farther from the front end of the vehicle after the engine is inclined.

The method may include the step of disposing an air intake for the engine on the front side of the engine, such that the air intake extends from the engine towards the front end of the body, and draws air into the engine from the direction of the front end of the body. The method also may include the step of disposing an exhaust for the engine on the front side of the engine, such that the exhaust extends from the engine towards the front end of the body, and expels exhaust from the engine towards the direction of the front end of the body.

The method further may include the step of disposing a fuel and/or air inlet device in communication with the engine on the front side of the engine, such that the inlet device is closer to the front end of the vehicle than the engine is.

### BRIEF DESCRIPTION OF THE DRAWINGS

Like reference numbers generally indicate corresponding elements in the figures.

FIG. 1 is a partial cross-sectional of an exemplary embodiment of a vehicle in accordance with the principles of the claimed invention.

FIG. 2 is an full-view illustration showing an exterior and partial cutaway of an exemplary embodiment of a vehicle in accordance with the principles of the claimed invention.

### DETAILED DESCRIPTION OF THE PREFERRED EMBODIMENT

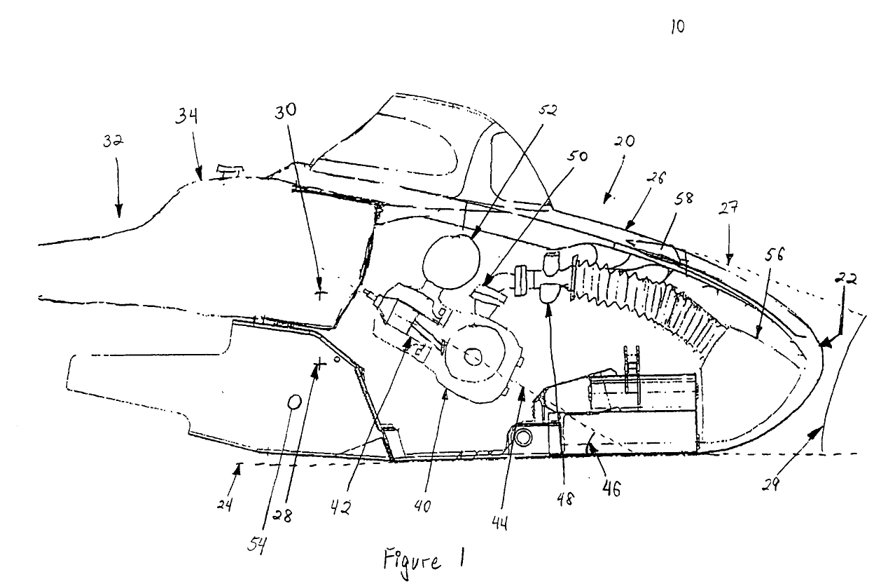

Referring to FIG. 1, a vehicle 10 in accordance with the principles of the claimed invention includes a vehicle body 20 with a front end 22. An engine 40 is disposed within the vehicle body 20.

For simplicity, FIG. 1 illustrates only the forward portion of the vehicle body 20, that portion with the engine 40 disposed therein. For some vehicles, the body 20 may extend further back than is illustrated.

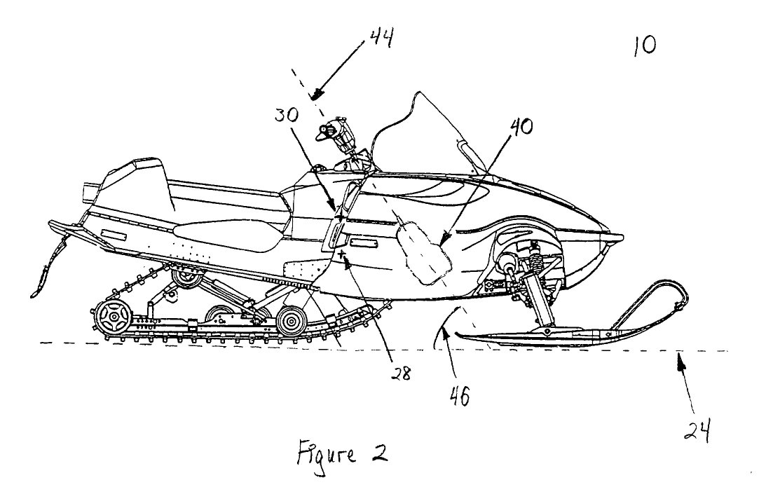

FIG. 2 illustrates the exterior of a complete vehicle 10, with a forward portion similar to that shown in FIG. 1.

However, the invention does not require a specific body shape, form, or configuration; the vehicle body 20 as illustrated is exemplary only. In particular, although the vehicle 10 illustrated in FIG. 2 and the partial vehicle body 20 as illustrated in FIG. 1 are representative of a snowmobile body, this is exemplary only, and a variety of other vehicles and vehicle bodies may be equally suitable.

The body 20 is adapted to rest substantially on a plane 24, such as the plane defined by the ground, a snow-covered surface, etc. The plane 24 need not be geometrically perfect.

The engine 40 defines at least one cylinder 42 therein. Each cylinder 42 in turn defines an axis 44. The engine 40 is inclined backwardly within the body 20, such that each of the axes 44 forms an angle 46 with the plane 24 in a direction away from the front end 22 of the body 20. The angle 46 is less than 90 degrees.

In a preferred embodiment, the angle 46 is less than 75 degrees.

In a more preferred embodiment, the angle 46 is less than 60 degrees.

In a yet more preferred embodiment, the angle 46 is less than 45 degrees.

In a still more preferred embodiment, the angle 46 is less than 30 degrees.

FIG. 2 shows the cylinder axes 44 in relation to a vehicle 10 as a whole, and also illustrates the angle 46 between the cylinder axes 44 and the plane 24 on which the vehicle 10 rests.

Returning to FIG. 1, although it shows only one cylinder 42 in the engine 40 illustrated therein, this is exemplary only. Engines 40 with two or more cylinders 42 may be equally suitable.

Many types of engine 40 may be suitable for use in the vehicle 10. In a preferred embodiment, the engine 40 is an internal combustion engine. In a more preferred embodiment, the engine 40 is a four-stroke internal combustion engine. However, this is exemplary only, and other types of engine 40, including but not limited to diesel and two-stroke internal combustion engines, may be equally suitable.

In engines 40 with more than one cylinder 42, the cylinders 42 may be aligned with one another, such that the axis 44 of each cylinder 42 forms approximately the same angle 46 with the plane 24 on which the vehicle body 20 rests.

However, in certain embodiments, the cylinders 42 may not all be aligned with one another. For example, in a conventional “V” arrangement engine, two rows of cylinders are defined, the rows being angled slightly with respect to one another. Such engines, as well as other engines having multiple non-aligned cylinders may be equally suitable for use in the claimed invention. In embodiments having such engines 40, although the axes 44 of the cylinders 42 may not all be equal, the engines 40 nevertheless are disposed in a similar fashion to that described above, namely, they are inclined such that each of the axes 44 of the cylinders 42 forms an angle 46 of less than 90 degrees with the plane 24 upon which the vehicle 10 rests, in a direction away from the front end 22 of the body 20.

In certain embodiments, the angle 46 may be similar to an angle 29 formed between the slope 27 of the surface 26 of the body 20 and the plane 24 upon which the body 20 rests, in the area proximate the engine 40.

In a preferred embodiment, the angle 46 and the angle 29 differ by 10 degrees or less.

In a more preferred embodiment, the angle 46 and the angle 29 differ by 5 degrees or less.

However, this is exemplary only. In certain embodiments, it may be equally suitable for the angles to differ by more than 10 degrees.

With the engine 40 inclined, the center of mass 28 of the vehicle 10 is lower than it otherwise would be if the engine 40 were not inclined, i.e. if the angle 46 were 90 degrees.

Similarly, with the engine 40 inclined, the center of mass 28 of the vehicle 10 is further from the front end 22 than it otherwise would be if the engine 40 were not inclined, i.e. if the angle 46 were 90 degrees.

These changes in the position of the center of mass 28 owe at least in part to the change in mass distribution as the engine 40 is inclined. As the engine 40 inclines, its center of mass moves backwards and downwards, which thus moves the center of mass 28 of the vehicle backwards and downwards.

However, these changes in the position of the center of mass 28 of the vehicle 10 do not exclude the possibility of moving the center of mass 28 in other ways. Indeed, inclining the engine 40 may also enable further changes in the location of the center of mass 28, i.e. backwards and/or downwards. For example, in its inclined configuration, the engine 40 may be translated backwards or downwards within the vehicle body 20 to a degree that might not be possible if the engine 40 were not inclined. However, this is exemplary only.

At least in part through inclination of the engine 40 to an angle 46 of less than 90 degrees, the center of mass 28 of the vehicle 10 may be made to substantially align vertically with the drive shaft 54 of the vehicle. Alternatively, the center of mass 28 of the vehicle 10 may be made to substantially align vertically with the geometric center 30 of the vehicle. As a further alternative, the center of mass 28 of the vehicle 10 may be made to substantially align vertically with the operator's location 32 on the vehicle.

FIG. 2 illustrates the relationship between the center of mass 28 and the geometric center 30 of an exemplary vehicle 10.

However, each of the aforementioned positions for the center of mass 28 with reference to both Figures and 2 is exemplary only. In certain embodiments, it may be suitable for the center of mass 28 to be located at other positions.

In addition, it is noted that the inclination and position of the engine 40 are not the only factors affecting the center of mass 28 of the vehicle 10. For example, for vehicles 10 adapted to carry more than one person, the number, size, and positions of persons on the vehicle will influence the location of the center of mass 28. Likewise cargo, varying quantities of fuel in fuel tank(s), etc. may affect the center of mass 28. In particular, the center of mass 28 may move from place to place within the vehicle 10 for a given embodiment.

Thus, it is to be understood that although the present invention may enable advantageous positioning of the center of mass 28, the center of mass 28 of the vehicle 10 is not entirely determined by the position and orientation of the engine 40, and is not fixed for any given vehicle 10.

Returning to FIG. 1, when the center of mass 28 is positioned advantageously by tilting the engine 40 to an angle 46, the performance of the vehicle 10 may be improved.

For example, for a vehicle 10 having an engine 40 inclined to an angle 46, the angle being less than 90 degrees, and consequently having a center of mass 28 that is substantially vertically aligned with the drive shaft 54, the geometric center 30 of the vehicle, the operator's location 32 on the vehicle, or some other advantageous location, the turning radius of that vehicle 10 may be less than would be the case if the engine 40 were not inclined, i.e. if the angle equals 90 degrees.

Similarly, for a vehicle 10 having an engine 40 inclined to an angle 46, the angle being less than 90 degrees, and consequently having a center of mass 28 that is lower than would be the case if the engine 40 were not inclined, the vehicle 10 may be more stable than it would be if the engine 40 were not inclined.

In addition, advantageous placement of the center of gravity 28 may be used to produce other improvements in the performance of the vehicle 10, including but not limited to a smoother ride, improved pitch control, and improved responsiveness to control by rider body position.

Furthermore, a vehicle 10 having an engine 40 inclined to an angle 46, the angle being less than 90 degrees, may demonstrate other advantages than those specifically described herein, including but not limited to advantages directly related to engine inclination and/or position, advantages indirectly related to engine inclination and/or position, and advantages unrelated to engine inclination and/or position.

For example, in certain embodiments the inclination of the engine 40 and the changes associated therewith (about which more description is provided below) may provide for more efficient cooling of the engine 40. In turn, in some embodiments improved cooling of the engine 40 may enable greater power output per pound of engine, thereby increasing the performance of the vehicle 10.

However, such advantages are exemplary only.

The vehicle 10 includes an air intake 50 in communication with the engine 40 for drawing air into the engine 40, and an exhaust port 52 in communication with the engine 40 for expelling exhaust gases from the engine 40.

In certain embodiments, the air intake 50 may extend from the engine towards the front end 22 of the vehicle body 20 so as to draw air into the engine in the direction of the front end 22. For example, as shown in FIG. 1 the air intake 50 is in communication with an air plenum 56, which in turn draws air in through an intake vent 58.

Similarly, in certain embodiments the exhaust port 52 may extend from the engine towards the front end 22 of the vehicle body 20 so as to expel exhaust in the direction of the front end 22.

In certain embodiments, both the air intake 50 and the exhaust port 52 may extend towards the front end 22. Such an arrangement may be advantageous at least insofar as facilitating inclination of the engine 40. Since neither the air intake 50 or the exhaust port 52 extends backwards in such an arrangement, they do not obstruct inclination of the engine 40.

In addition, in some embodiments such an arrangement of the air intake 50 and the exhaust port 52 may facilitate other advantages besides enabling inclination of the engine 40. 20 For example, arranging the air intake 50 to extend towards the front end 22 of the vehicle body 20 may enable air to be drawn in from at or near the front end 22, i.e. through an external air vent at or near the front end 22. With such an arrangement, engine noise as perceived by the operator may be reduced, since the path from the engine 40 through the air intake 50 does not open to the outside of the vehicle 25 near the operator, that is, the distance between operator and outside air vent is increased.

Also, in embodiments wherein the air intake 50 and exhaust port 52 extend towards the front end 22 of the vehicle body 20, more space may be available behind the engine 40 for structures such as the fuel tank 34. Thus, in some embodiments inclination of the engine 40 may enable a greater fuel capacity and increased range than with a non-inclined engine.

Furthermore, arranging the air intake 50 and exhaust port 52 so as to extend towards the front end 22 of the vehicle body 20 may enable the operator location 32 to be moved closer to the center of mass 28. For example, because neither the air intake 50 nor the exhaust port 52 extend towards the rear of the engine 40, it is not necessary to provide space behind the engine 40 for those components. Consequently, in certain embodiments the operator location 32 may be moved forward to better align with the center of mass 28.

However, an arrangement wherein the air intake 50 and/or exhaust port 52 extend towards the front end 22 of the vehicle body 20 is exemplary only, and other arrangements may be equally suitable.

Furthermore, it is noted that even when either or both of the air intake 50 and the exhaust port 52 extend towards the front end 22 of the vehicle body 20, it is not necessary that the path from either the air intake 50 or the exhaust port 52 extend continuously toward the front end 22.

For example, as shown in FIG. 1 the air intake 50 is in communication with an air plenum 56, which in turn draws air in through an intake vent 58. However, the plenum 56 is closer to the front end 22 than the intake vent 58, so even though air enters the engine 40 from the direction of the front end 22, the air is not always moving from front to back, i.e. while traveling from intake vent 58 to air plenum 56 it is moving back to front.

In addition, it is not necessary that the path from either the air intake 50 or the exhaust port 52 extend ultimately toward the front end 22. Although the intake vent 58 is shown disposed forward of the engine 40 in FIG. 1, this is exemplary only. In certain embodiments, the intake vent 58 may be approximately aligned with or behind the engine 40. Likewise, an exhaust vent for venting exhaust to the outside of the vehicle (not shown) may be ahead of, even with, or behind the engine 40.

In other words, although in certain embodiments the air intake 50 and/or the exhaust port 52 may draw air from and/or expel exhaust in the direction of the front end 22, they will not necessarily draw air at and/or expel exhaust to the vicinity of the front end 22. Indeed, in certain embodiments exhaust ultimately might be expelled to another location entirely, i.e. behind or beside the engine 40, and air ultimately might be drawn in from another location entirely as well.

In some embodiments the vehicle 10 may include an inlet device 48 in communication with the engine 40, and/or in communication with the air intake 50, for controlling fuel and/or air fed to the engine 40. The inlet device 48 may extend from the engine towards the front end 22 of the vehicle body 20 so as to draw air into itself from the direction of the front end 22.

A variety of inlet devices 48 may be suitable for use with the claimed invention. Suitable inlet devices 48 include, but are not limited to, carburetors, fuel injector systems such as fuel inlet throttle bodies, and air inlet systems such as air inlet throttle bodies. The use of multiple inlet devices 48, i.e. one for controlling fuel and one for controlling air, may be equally suitable for certain embodiments. In addition, inlet devices 48 that control the inlet of both fuel and air into the engine also may be suitable for some embodiments. Suitable inlet devices 48 are well known, and are not described further herein.

Although the inlet device 48 in the exemplary embodiment illustrated in FIG. 1 is shown to be in communication with the engine 40 via the air intake 50, this is exemplary only. Other arrangements may be equally suitable. Suitable arrangements for a inlet device 48 may depend at least in part on the structure and operation of the inlet device 48 itself. For example, in certain embodiments, the inlet device 48 may include a so-called “direct fuel injection” system for introducing fuel directly into the engine 40; in such an embodiment, the inlet device 48 will not necessarily be connected with the air intake 50.

As with the exemplary arrangement described above wherein the air intake 50 and the exhaust port 52 extend towards the front end 22, an arrangement wherein the inlet device 48 extends towards the front end 22 may be advantageous at least insofar as facilitating inclination of the engine 40. Since the inlet device 48 does not extend backwards in such an arrangement, it does not obstruct inclination of the engine 40.

In addition, as with the exemplary arrangement described above wherein the air intake 50 and the exhaust port 52 on extending towards the front end 22, an arrangement wherein the inlet device 48 extends towards the front end 22 may facilitate other advantages besides enabling inclination of the engine 40.

However, such an arrangement for the inlet device 48 is exemplary only, and other arrangements may be equally suitable.

Furthermore, the use of a inlet device 48 is exemplary only, and embodiments without an inlet device 48 may be equally suitable.

The above specification, examples and data provide a complete description of the manufacture and use of the composition of the invention. Since many embodiments of the invention can be made without departing from the spirit and scope of the invention, the invention resides in the claims hereinafter appended.

1. A vehicle comprising:
a body comprising a front end, said body being adapted to rest substantially on a plane; and
an engine disposed within said body, said engine comprises at least one cylinder therein, and each of said at least one cylinder defining an axis thereof;
wherein an angle between each of said axes and said plane in a direction away from said front end of said body is less than 90 degrees.

2. The vehicle according to claim 1, wherein said angle is less than 75 degrees.

3. The vehicle according to claim 1, wherein said angle is less than 60 degrees.

4. The vehicle according to claim 1, wherein said angle is less than 45 degrees.

5. The vehicle according to claim 1, wherein said angle is less than 30 degrees.

6. The vehicle according to claim 1, wherein a center of mass of said vehicle with said angle being less than 90 degrees is lower than a center of mass of said vehicle with said angle being equal to 90 degrees.

7. The vehicle according to claim 1, wherein a center of mass of said vehicle with said angle being less than 90 degrees is farther from said front end of said body than a center of mass of said vehicle with said angle being equal to 90 degrees.

8. The vehicle according to claim 1, wherein a center of mass of said vehicle is substantially vertically aligned with a location of an operator disposed on said vehicle.

9. The vehicle according to claim 1, wherein said vehicle comprises a drive shaft therein in engagement with said engine, and a center of mass of said vehicle is substantially vertically aligned with said drive shaft.

10. The vehicle according to claim 1, wherein a center of mass of said vehicle is substantially vertically aligned with a geometric center of said vehicle.

11. The vehicle according to claim 1, wherein a turn radius of said vehicle with said angle being less than 90 degrees is smaller than a turn radius of said vehicle with said angle being equal to 90 degrees.

12. The vehicle according to claim 1, wherein said vehicle further comprises an air inlet in communication with said engine, said air inlet being disposed closer to said front end of said vehicle than said engine.

13. The vehicle according to claim 1, wherein said vehicle further comprises:
an air intake in communication with said engine, said air intake extending from said engine in a direction towards said front end of said body so as to draw air into said engine from said direction towards said front end of said body; and
an exhaust port in communication with said engine, said exhaust port extending from said engine in a direction towards said front end of said body so as to expel exhaust from said engine in said direction towards said front end of said body.

14. The vehicle according to claim 1, wherein said vehicle is a snowmobile.

15. Method of mounting an engine in a vehicle, comprising the steps of:
providing a vehicle body adapted to rest substantially on a plane, said vehicle body comprising a front end;
providing an engine comprising at least one cylinder therein, each of said at least one cylinder defining an axis thereof;
disposing said engine within said body such that an angle between each of said axes and said plane in a direction away from said front end of said body is less than 90 degrees.

16. Method of changing a center of mass of a vehicle comprising:
a body adapted to rest substantially on a plane, said body comprising a front end; and
an engine disposed within said body, said engine comprising at least one cylinder therein, each of said at least one cylinder defining an axis thereof;
the method comprising the step of:
inclining said engine within said body such that an angle between each of said axes and said plane in a direction away from said front end of said body is less than 90 degrees;
whereby as said engine is inclined, said center of mass of said vehicle moves.

17. Method according to claim 16, wherein:
a center of mass of said vehicle after inclining said engine is lower than a center of mass of said vehicle before inclining said engine.

18. The vehicle according to claim 16, wherein a center of mass of said vehicle after inclining said engine is farther from said front end of said body than a center of mass of said vehicle before inclining said engine.

19. Method according to claim 16, wherein said vehicle further comprises an inlet device in communication with said engine;
the method further comprising the step of disposing said inlet device closer to said front end of said vehicle than said engine.

20. Method according to claim 16, wherein said vehicle further comprises an air intake in communication with said engine and an exhaust port in communication with said engine;
the method further comprising the steps of:
disposing said air intake to extend from said engine in a direction towards said front end of said body, so as to draw air into said engine from said direction towards said front end of said body; and
disposing said exhaust port to extend from said engine in a direction towards said front end of said body so as to expel exhaust from said engine in said direction towards said front end of said body.
